(19) United States
(12) Patent Application Publication
(10) Pub. No.: US 2013/0183907 A1
(43) Pub. Date: Jul. 18, 2013

(54) BEAM COMPENSATION METHOD AND BASE STATION IN A WIRELESS COMMUNICATION SYSTEM

(71) Applicant: Samsung Electronics Co., Ltd., Gyeonggi-do (KR)

(72) Inventors: Yonghoon KIM, Gyeonggi-do (KR); Mihyun SON, Seoul (KR); Byungtae YOON, Gyeonggi-do (KR); Jongwook ZEONG, Seoul (KR); Donggeun LEE, Gyeonggi-do (KR)

(73) Assignee: Samsung Electronics Co., Ltd., Gyeonggi-do (KR)

(21) Appl. No.: 13/740,566

(22) Filed: Jan. 14, 2013

(30) Foreign Application Priority Data
Jan. 12, 2012 (KR) 10-2012-0003653

(51) Int. Cl. H04W 24/02

(52) U.S. Cl. CPC H04W 24/02
USPC 455/67.11; 455/562.1

(57) ABSTRACT

A beam compensation method and a base station are provided for improving system throughput of a wireless communication system. The beam compensation method includes monitoring feedback signals of a plurality of radio paths; detecting an abnormally operating radio path, based on the monitoring; retrieving beam compensation values corresponding to the abnormally operating radio path; and compensating signals on normally operating radio paths with the retrieved beam compensation values.

### PRIORITY

This application claims priority under 35 U.S.C. §119(a) to Korean Patent Application Serial No. 10-2012-0003653, which was filed in the Korean Intellectual Property Office on Jan. 12, 2012, the entire disclosure of which is incorporated herein by reference.

### BACKGROUND OF THE INVENTION

1. Field of the Invention

The present invention relates generally to a wireless communication system and, more particularly, to a beam compensation method and base station in a wireless communication system.

2. Description of the Related Art

In legacy wireless communication systems, a base station includes a Radio Frequency (RF) unit and a passive antenna array configured as separate blocks, in which all of the antennal elements are connected to a radio module. Recently, an Active Antenna System (AAS) has been proposed that integrates individual radio modules equipped with respective antenna elements.

In a legacy base station structure, however, if a radio module is malfunctioning, there is no way to provide terminals with services, until the radio module is replaced or fixed. However, the AAS is capable of maintaining function to some extent, even when abnormal operation is detected on some radio paths, using Built-In Redundancy (BIR).

In order to maximize the advantages of the integrated base station, it is important to minimize performance degradation on radio paths where an abnormal operation is detected. However, no such a technique has been proposed yet.

### SUMMARY OF THE INVENTION

The present invention has been designed in an effort to solve the above-described problems occurring in the prior art and to provide at least the advantages described below.

An aspect of the present invention is to provide a beam compensation method and base station equipped with an active antenna system that minimize antenna performance degradation, when an abnormal operation is detected on a radio path, by compensating output values on other radio paths that are operating normally in the base station equipped.

In accordance with an aspect of the present invention, a beam compensation method of a base station in a wireless communication system includes monitoring feedback signals of a plurality of radio paths; detecting an abnormally operating radio path, based on the monitoring; retrieving beam compensation values corresponding to the abnormally operating radio path; and compensating signals on normally operating radio paths with the retrieved beam compensation values.

In accordance with another aspect of the present invention, a base station for performing beam compensation in a wireless communication system includes a plurality of antennas; a plurality of radio modules that are connected to the plurality of antennas, respectively, forming a plurality of radio paths and communicating signals through radio channels; a storage unit that stores beam compensation values; an abnormal radio path detector that monitors feedback signals on the radio paths to detect an abnormally operating radio path; and a compensator that retrieves beam compensation values and compensates signals on normally operation radio paths with the beam compensation values, when the abnormally operating radio path is detected.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a circuit diagram illustrating an AAS according to an embodiment of the present invention;

FIG. 2 is a block diagram illustrating a base station according to an embodiment of the present invention;

FIG. 3 is a circuit diagram illustrating a base station according to an embodiment of the present invention;

FIG. 4 is a block diagram illustrating a base station according to an embodiment of the present invention;

FIG. 5 is a circuit diagram illustrating a base station according to an embodiment of the present invention;

FIG. 6 is a flowchart illustrating a beam compensation method of a base station according to an embodiment of the present invention;

FIG. 7A illustrates a normal beam pattern formed by an antenna array;

FIG. 7B illustrates a beam pattern formed by antennas including at least one abnormally operating antenna in a conventional antenna array; and

FIG. 7C illustrates beam pattern acquired by compensating for distortion caused by a radio path operating abnormally, according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

In the following description, when a radio path operates abnormally, this indicates that at least one component of a radio module has malfunctioned, e.g., due to an internal/external cause (electrical, mechanical, or environmental), thereby failing to perform an intended function of the radio module.

Herein, the term “module” refers a hardware device or a combination of a hardware device and software. For example, the term “radio module” means a transceiver including a front end (i.e., a duplexer, a diplexer, a filter, a low noise filter, etc.), a Power Amplifier (PA), and an Analog Digital Converter (ADC)/Digital Analog Converter (DAC).

In a conventional base station, a plurality of antenna elements are connected to a radio module, and the amplitude ratio and phase difference of a signal supplied to each antenna is fixed. Further, in the conventional base station, when the radio module operates abnormally, i.e., when an operation failure is detected, the base station cannot provide service until the radio module is replaced or fixed.

As described above, in order to overcome this problem, the AAS is configured with a plurality of radio modules connected with individual antenna elements (1:1) in a distributed manner. From such a structural feature, the AAS is capable of maintaining the antenna power over a predetermined level, even when some of the radio modules operate abnormally.

However, the AAS is not allowed to adjust the amplitude ratio and phase difference of the signal supplied to the each antenna element like the conventional antenna. Consequently, the service is provided in a distorted radiation pattern (e.g., with an upper side lobe enlargement, a main load gain reduction, main lobe direction distortion, etc.) when compared to an intended radiation pattern.

Therefore, in accordance with an embodiment of present invention, a method is provided for compensating for the distortion in the beam, when at least one of the radio modules operates abnormally, by adjusting an amplitude ratio and a phase difference of the signal supplied to the antenna elements connected through the radio paths that are operating normally. By compensating the beam in this manner, it is possible to provide an antenna radiation pattern that is at least similar the intended radiation pattern, which occurred before the abnormal operation.

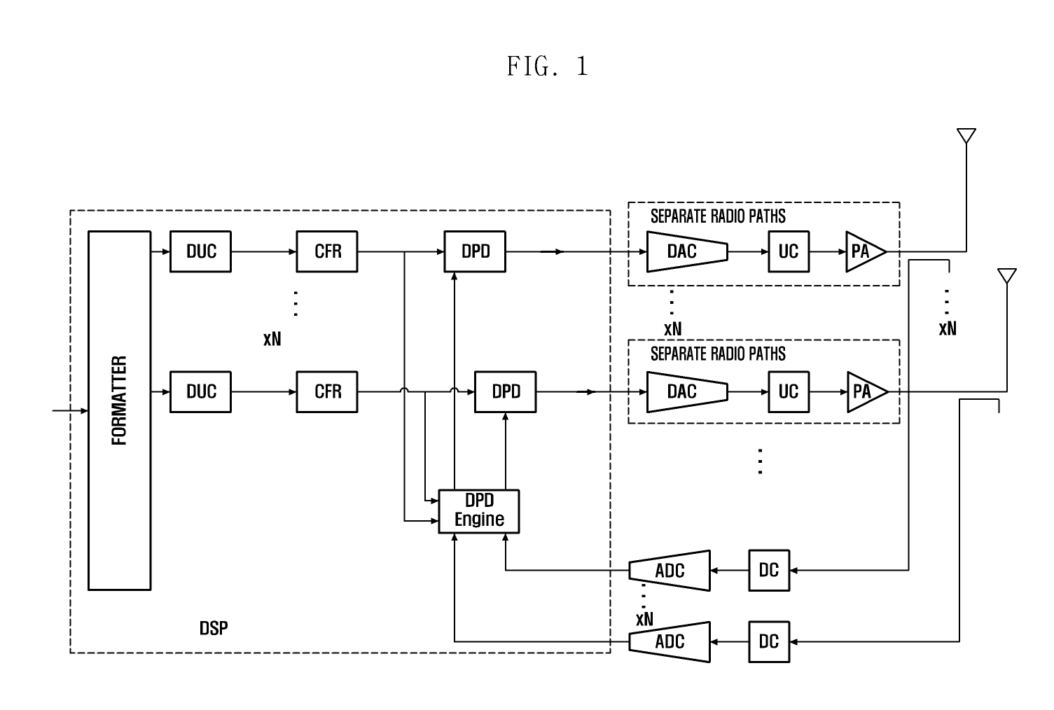

FIG. 1 is a circuit diagram illustrating a normal configuration of an AAS according to an embodiment of the present invention. Specifically, in FIG. 1, the AAS is structured in such a way that a plurality of antenna elements are distributed through different radio paths.

Using the AAS illustrated in FIG. 1, it is possible to maintain the functionality to some extent, even when an abnormal operation is detected on a radio path, thanks to the BIR.

According to an embodiment of the present invention, an AAS includes a circuit that monitors whether each radio path operates normally and a compensation circuit that compensates the amplitude and phase on each radio path.

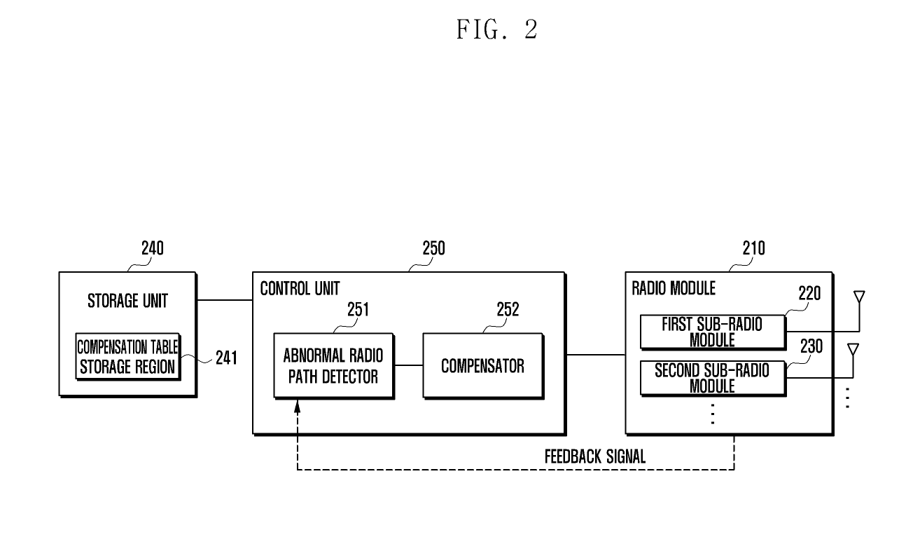

FIG. 2 is a block diagram illustrating a base station according to an embodiment of the present invention.

Referring to FIG. 2, the base station includes a radio module 210, a storage unit 240, and a control unit 250. Herein, the term “unit” refers to a hardware device or a combination of a hardware device and software.

The radio module 210 performs radio communication. Although not illustrated, the radio module 210 includes an RF transmitter for up-converting and amplifying signals to be transmitted and an RF receiver for low noise amplifying and down-converting received signals. The radio module 210 receives data through a radio channel and transfers the received data to the control unit 250 and transmits data output by the control unit 250 through the radio channel.

In accordance with an embodiment of the present invention, the radio module 210 includes sub-radio modules 220 and 230, which are connected to respective antennas. Signal paths established through the sub-radio modules 220 and 230 and their respective antennas are referred to as radio paths. Accordingly, multiple radio paths are formed by sub-radio module-antenna pairs.

A signal emitted through each antenna is fed back to an abnormal radio path detector 251 of the control unit 250.

The storage unit 240, e.g., a memory device, stores various data and programs associated with beam compensation and other services provided by the base station. The storage unit 240 stores the programs and data associated with adjusting output values of normally operating radio paths, when other radio paths operate abnormally, in order to compensate for the distorted beam pattern. For example, the storage unit 240 includes a compensation table storage region 241 for storing a compensation table.

The compensation table stores the compensation values for use in compensating the output values of the normally operating radio paths, when any abnormally operating radio path is detected.

According to an embodiment of the present invention, the compensation table storage region 241 includes a lookup table. Here, the lookup table is a digital data structure having the output signal values predetermined according to the input signal level and one output value is determined according to one input level.

Table 1 below provides an example of a compensation table for compensating a signal in a digital front end (i.e., a control unit).

TABLE 1

Complex Coefficient

| Failed Path | Path 1 | Path 2 | Path 3 | Path 4 |
|---|---|---|---|---|
| No Failure | Ca0 | Cb0 | Cc0 | Cd0 |
| (default) | | | | |
| 1 | — | Cb1 | Cc1 | Cd1 |
| 2 | Ca2 | — | Cc2 | Cd2 |
| 3 | Ca3 | Cb3 | — | Cd3 |
| 4 | Ca4 | Cb4 | Cc4 | — |

Using Table 1, the digital front end compensates the signals by multiplying the radio paths by a complex compensation coefficient.

Specifically, using an AAS system having 4 radio paths, when a signal failure occurs on the second radio path established with the second sub-radio module and the second antenna, the first, third, and fourth radio paths are multiplied by the complex coefficients Ca2, Cc2, and Cd2, respectively. The compensation complex coefficients are the complex numbers, which are pre-calculated, for use in maintaining a similar radiation pattern as the radiation pattern in a normal operational state.

The control unit 250 controls the overall operation of the base station. Particularly, when a radio path operates abnormally, the control unit 250 compensates the output values of the other radio paths, which are operating normally, in order to compensate for (or correct) distortion of the radiation pattern. In FIG. 1, the control unit 250 includes an abnormal radio path detector 251 and a compensator 252.

The abnormal radio path detector 251 receives output feedback signals on the radio paths to determine whether each radio path operates normally. If an abnormal operation is detected on any radio path, the abnormal radio path detector 251 notifies the compensator 252 of the number and positions of abnormally operating radio paths.

The compensator 252 receives the information on the number of the abnormally operating radio paths and positions of the abnormally operation radio paths from the abnormal radio path detector 251, checks the beam compensation values stored in the storage unit 240, and compensates the signals on the normally operating radio paths with the checked beam compensation values. The compensator 252 is included in the digital front end, i.e., the control unit 250, and compensates the signals by multiplying the corresponding radio paths with complex compensation coefficients, as shown in Table 1.

Although the control unit 250, the abnormal radio path detector 251, and the compensator 252 are illustrated as separate devices, that are responsible for different functions, the present invention is not limited thereto. For example, the function of the compensator 252 and/or the function of abnormal radio path detector 251 can be integrated into the control unit 250.

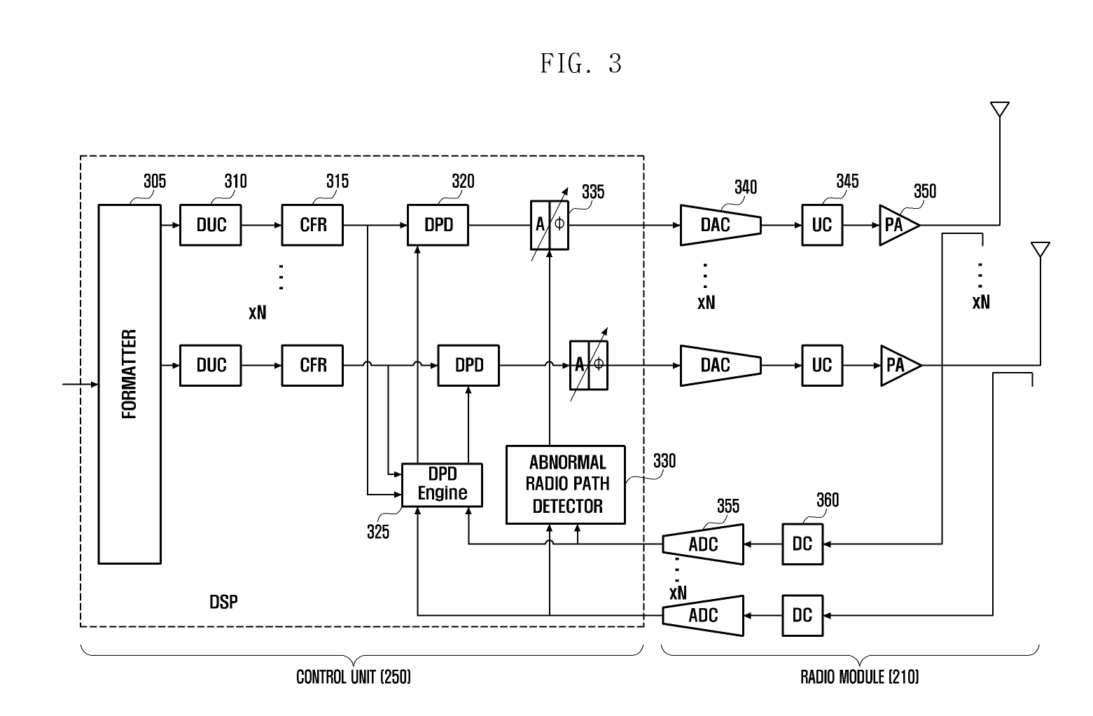

FIG. 3 is a circuit diagram illustrating a base station according to an embodiment of the present invention. Specifically, FIG. 3 illustrates the circuitry of the control unit 250 and the radio module 210 illustrated in FIG. 2.

Referring to FIG. 3, the formatter 305, e.g., a Serial-to-Parallel (S/P) converter, converts the fast serial signal to slow complex parallel signals.

The Digital Up Convertors (DUCs) 310 separate individual baseband signals from the complex parallel signals output by the formatter 305, filter the baseband signals, and digitally up convert the filtered signals to a combined digital Intermediate Frequency (IF) signal.

The Crest Factor Reducers (CFRs) 320 reduce the Peak to Average Ratio of the signals combined by the DUCs 310.

The Digitally Pre-Distorters (DPDs) 320 pre-distort the signals output by the CFRs 315 to improve the linearity of a Power Amplifier (PA).

The DPD engine 325 is responsible for digitally down-converting (i.e., filtering, decimation, etc.) the PA output signal, i.e., a Power Amplifier output signal output from a PA 350, converted to the digital IF signal. The DPD engine 325 is responsible for controlling the DPDs 325 to perform beam forming and adaptation procedure with a reference signal input to the DPDs 320.

The abnormal radio path detector 330 receives feedback signals about the radio paths and determines whether each radio path operates normally. If any radio path is operating abnormally, the abnormal radio path detector 330 notifies the compensator 335 of the number of abnormally operating radio paths and the positions of the abnormally operating radio paths.

The compensators 335 receive the information on the number of abnormally operation radio paths and positions of the abnormally operating ratio paths. The compensators 335 check the beam compensation values from the lookup table stored in the storage unit and compensate the signals on the radio paths that are operating normally with the checked beam compensation values.

According to an embodiment of the present invention, the compensators 335 are positioned in a digital front end, i.e., the control unit 250, as illustrated in FIG. 3, and compensate the signals by multiplying the radio paths with the complex compensation coefficients.

The DACs 340 convert the digital IF signals output by the compensators 335 to analog IF signals. Here, the digital IF signals are the signals compensated by multiplying the complex compensation coefficient by the compensator.

The Up Converters (UCs) convert the analog IF signals output by the DACs 340 to RF signals.

The Power Amplifiers (PAs) 350 amplify the RF signals output by the transmission block (TX block) of the transceiver to a specific level at the antenna ports.

The Down Converters (DCs) 360 down-convert the output signals of the PAs 350, i.e., feedback signals, to analog IF signals.

The Analog Digital Converters (ADCs) 335 convert the analog IF signals to digital IF signals, which are provided to the DPD engine 325 and the abnormal radio path detector 330.

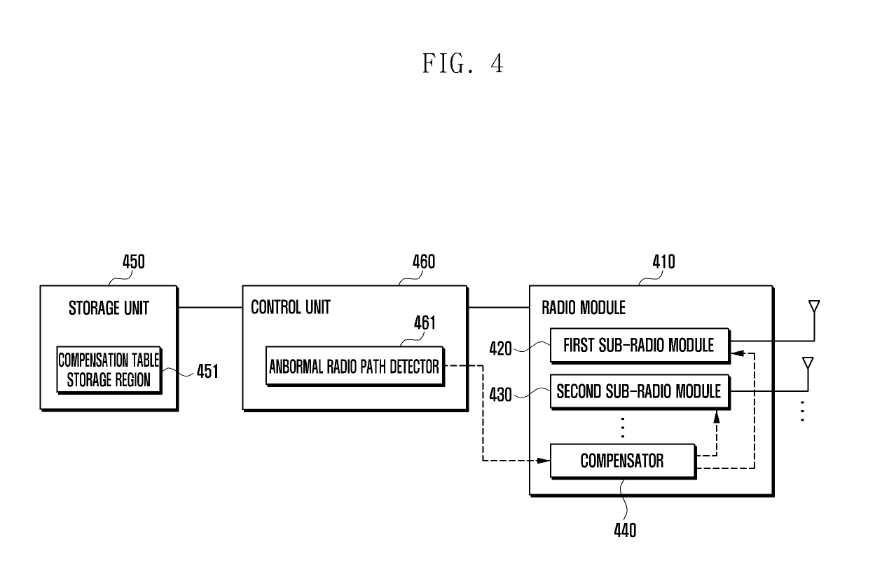

FIG. 4 is a block diagram illustrating a base station according to an embodiment of the present invention.

Referring to FIG. 4, the base station includes a radio module 410, a storage unit 450, and a control unit 460.

The internal configuration of the base station illustrated in FIG. 4 differs from that of FIG. 2 in that the compensator 440 included in the radio module 410, instead of being included in the control unit 460.

The radio module 410 is responsible for radio communication. Although not illustrated, the radio module 410 includes an RF transmitter for up-converting and amplifying signals to be transmitted and an RF receiver for low noise amplifying and down-converting received signals. The radio module 410 receives data through a radio channel and transfers the received data to the control unit 460 and transmits data output by the control unit 250 through the radio channel.

The radio module 410 includes sub-radio modules 420 and 430, which are connected to respective antennas.

The compensator 440 is included in the radio module 410, i.e., the analog RF end, to adjust the amplitudes and phases of output signals. In order to accomplish this, the compensator 440 includes a variable attenuator and a variable phase shifter for adjusting the amplitude and phase of a signal.

The storage unit 450 stores various data and programs associated with the beam compensation and other services provided by the base station. The storage unit 450 stores the programs and data associated with adjusting the output values of normally operating radio paths, when any radio path operates abnormally, in order to compensate for the distorted beam pattern. For example, the storage unit 450 includes a compensation table storage region 241 for storing a compensation table.

Table 2 shows an example of a compensation table according to an embodiment of the present invention.

TABLE 2

| | Amplitude ratio of power supply signal | | | | Phase difference of power supply signal | | | |
|---|---|---|---|---|---|---|---|---|
| | per antenna element | | | | per antenna element | | | |
| Failed Path | Path 1 | Path 2 | Path 3 | Path 4 | Path 1 | Path 2 | Path 3 | Path 4 |
| No failure | Aa0 | Ab0 | Ac0 | Ad0 | Pa0 | Pb0 | Pc0 | Pd0 |
| (default) | | | | | | | | |
| 1 | — | Ab1 | Ac1 | Ad1 | — | Pb2 | Pc1 | Pd1 |
| 2 | Aa2 | — | Ac2 | Ad2 | Pa2 | — | Pc2 | Pd2 |
| 3 | Aa3 | Ab3 | — | Ad3 | Pa3 | Pb3 | — | Pd3 |
| 4 | Aa4 | Ab4 | Ac4 | — | Pa4 | Pb4 | Pc4 | — |

Using table 2, the compensator 440 compensates the signal by adjusting the amplitude and phase of the signal using the variable attenuator and the variable phase shifter.

More specifically, in an AAS system having 4 radio paths, when a signal failure occurs at the second sub-radio module, the amplitude rates on the first, third, and fourth radio paths are compensated by replacing the initial default values of Aa0, Ac0, and Ad0 with Aa2, Ac2, and Ad2. Simultaneously, the phase differences on the first, third, and fourth radio paths are compensated by replacing the initial default values of Pa0, Pc0, and Pd0 with Pa2, Pc2, and Pd2. Even though the second radio path operates abnormally, it is possible to maintain an intended radiation pattern by compensating the signals in amplitude rate and phase difference.

The control unit 460 controls signal the overall operation of the base station. Particularly, when a radio path operates abnormally, the control unit 460 controls the compensator 440 to compensate the output values of other radio paths, which are operating normally, in order to compensate for the distortion of the radiation pattern. Accordingly, the control unit 460 includes an abnormal radio path detector 461.

The abnormal radio path detector 461 receives feedback signals on the radio paths to determine whether each radio path operates normally. If an abnormal operation is detected on any radio path, the abnormal radio path detector 461 notifies the compensator 440 (of the radio module 410) of the number and positions of abnormally operating radio paths.

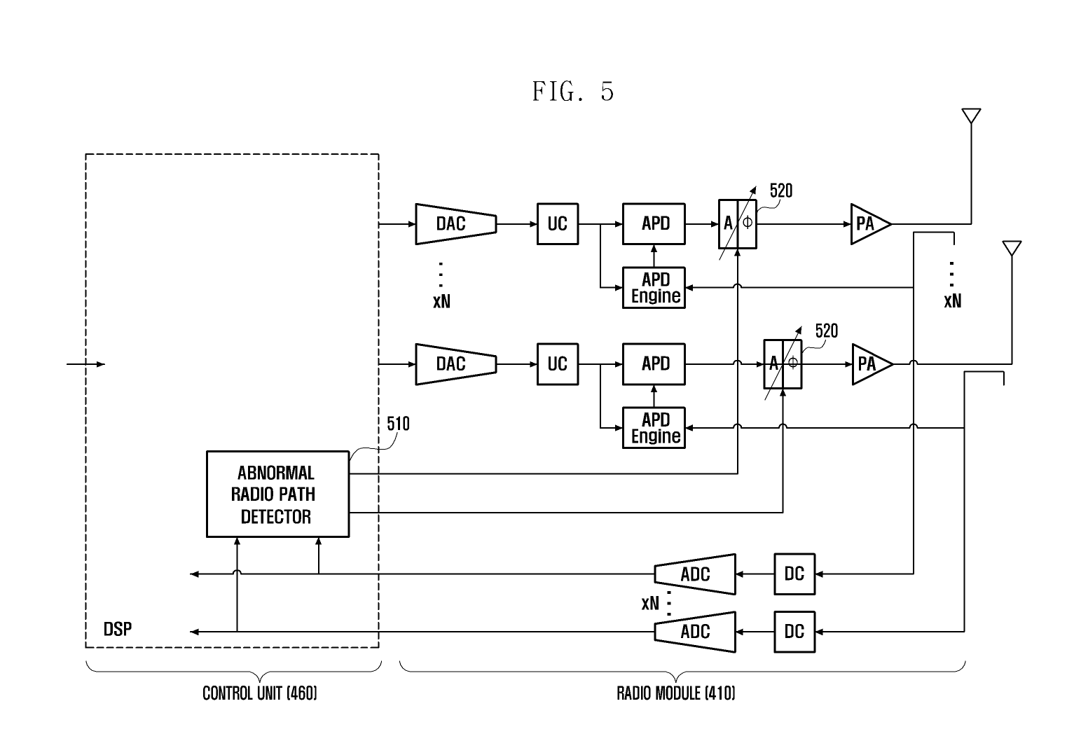

FIG. 5 is a circuit diagram illustrating a base station according to an embodiment of the present invention. Specifically, FIG. 5 illustrates the circuitry structure of the control s unit 460 and the radio module 410 as illustrated in FIG. 4. In the following description of FIG. 5, detailed descriptions of components that have already described with reference to FIG. 3 are omitted herein.

Referring to FIG. 5, the abnormal radio path detector 510 receives the output feedback signals about the radio paths to determine whether the radio paths operate normally. If an abnormally operating radio path is detected, the abnormal radio path detector 510 notifies the compensator 520 of the number of abnormally operating radio paths and positions of the abnormally operating radio paths.

The compensator 520 is positioned in the analog RF front end, i.e., the radio module 410, and compensates the signals in amplitude and phase using the variable attenuator and the variable phase shifter.

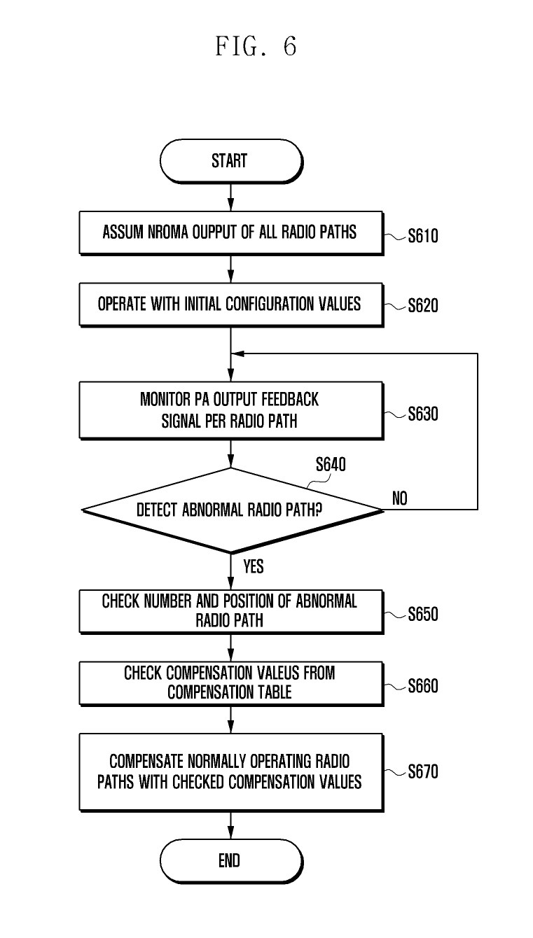

FIG. 6 is a flowchart illustrating a beam compensation method of a base station according to an embodiment of the present invention.

Referring to FIG. 6, in step S610, all of the radio path are operating normally, and in step S620, the base station forms a beam with initial configuration values.

In step S630, the base station monitors the feedback signal from the PA output node of each radio path, and in step S640, determines whether an abnormally operating radio path is detected.

When an abnormally operation radio path is detected in step S640, the base station checks the number and positions of the abnormally operating radio paths in step S650. In step S660, the base station looks up the compensation values to be applied to the radio paths operating normally, from the compensation table stored in the storage unit.

When beam compensation is performed by a digital front end, as illustrated in FIG. 2, the base station compensates the signals by multiplying the radio paths by respective complex compensation coefficients. Otherwise, when the beam compensation is performed by the analog front end, as illustrated in FIG. 4, the base station compensates the signals by adjusting the amplitudes and phases of the signals on the radio paths.

In step S670, the base station compensates the signals on the radio paths operating normally with the checked compensation values.

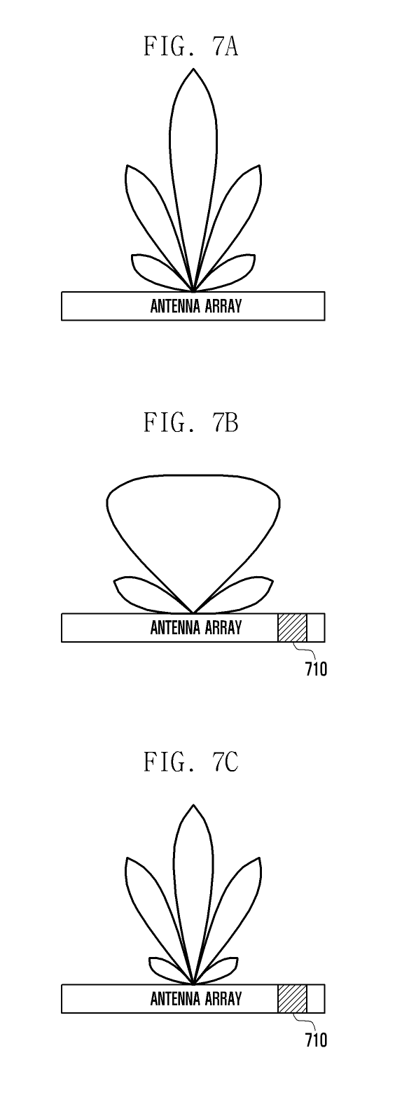

FIGS. 7A to 7C are diagrams illustrating beam patterns to explain an advantageous effect of beam compensation according to an embodiment of the present invention.

FIG. 7A is a diagram illustrating a normal beam pattern formed by the antenna array. Specifically, FIG. 7A illustrates a beam pattern formed when all of the radio paths are operating normally.

FIG. 7B is a diagram illustrating a beam pattern formed by the antennas including at least one abnormally operating antenna in a conventional antenna array. As illustrated in FIG. 7B, when an operation failure is detected on a radio path as denoted by reference number 710, the beam is distorted into an unintended shape (e.g., with an upper side lobe enlargement, a main lobe reduction, a main lobe direction change, etc.).

FIG. 7C is a diagram illustrating a beam pattern acquired by compensating distortion caused by a radio path operating abnormally according to an embodiment of the present invention.

Referring to FIG. 7C, although there is at least one abnormally operating radio path, the base station according to an embodiment of the present invention maintains similar the radiation pattern, as formed when all radio paths are operating normally. That is, the radiation pattern illustrated in FIG. 7C is similar to the radiation pattern illustrated in FIG. 7A, even though a radio path is operating abnormally.

As described above, beam compensation methods and base stations including an AAS minimize antenna performance degradation caused by the abnormal operation of at least one of the radio paths of the active antenna system.

Additionally, gain reduction and side love level increase caused by the abnormal operation of some radio paths are minimized, thereby providing terminals with constant services at a certain quality level.

Furthermore, the beam compensation methods and base stations of the present invention provide a compensation algorithm based on lookup data in order to simplify the compensation operation as compared with the real-time compensation value calculation-based method.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A beam compensation method of a base station in a wireless communication system, the method comprising:
monitoring feedback signals of a plurality of radio paths;
detecting an abnormally operating radio path, based on the monitoring;
retrieving beam compensation values corresponding to the abnormally operating radio path; and
compensating signals on normally operating radio paths with the retrieved beam compensation values.

2. The method of claim 1, wherein each of the radio paths is established by a radio module and an antenna.

3. The method of claim 1, wherein the beam compensation values are retrieved according to a number of abnormally operating radio paths and positions of the abnormally operation radio paths.

4. The method of claim 1, wherein the beam compensation values are retrieved from a lookup table including complex compensation coefficients for the normally operating radio paths.

5. The method of claim 4, wherein the complex compensation coefficients are determined according to the abnormally operating radio path.

6. The method of claim 1, wherein checking the beam compensation values are retrieved from a lookup table including amplitude ratios and phase differences for the normally operating radio paths.

7. The method of claim 6, wherein the amplitude ratios and the phase differences are determined according to the abnormally operating radio path.

8. A base station for performing beam compensation in a wireless communication system, the base station comprising:
a plurality of antennas;
a plurality of radio modules that are connected to the plurality of antennas, respectively, forming a plurality of radio paths and communicating signals through radio channels;
a storage unit that stores beam compensation values;
an abnormal radio path detector that monitors feedback signals on the radio paths to detect an abnormally operating radio path; and
a compensator that retrieves beam compensation values and compensates signals on normally operation radio paths with the beam compensation values, when the abnormally operating radio path is detected.

9. The base station of claim 8, wherein the beam compensation values are retrieved according to a number of abnormally operating radio paths and positions of the abnormally operation radio paths.

10. The base station of claim 8, wherein the storage unit stores a lookup table including complex compensation coefficients for the normally operating radio paths.

11. The base station of claim 10, wherein the complex compensation coefficients are determined according to the abnormally operating radio path.

12. The base station of claim 10, wherein the compensator retrieves the complex compensation coefficients from the lookup table and compensates signals on the normally operating radio paths with the retrieved complex compensation coefficients.

13. The base station of claim 8, wherein the storage unit stores a lookup table including amplitude ratios and phase differences for the normally operating radio paths.

14. The base station of claim 13, wherein the amplitude ratios and the phase differences are determined according to the abnormally operating ratio path.

15. The base station of claim 13, wherein the compensator retrieves the amplitude ratios and the phase differences from the lookup table and compensates signals on the normally operating radio paths with the retrieved amplitude ratios and the retrieved phase differences.
